(19) United States
(12) Patent Application Publication
(10) Pub. No.: US 2008/0019226 A1
(43) Pub. Date: Jan. 24, 2008

(54) Hierarchical storage apparatus and method for managing storage medium thereof

(75) Inventors: Koutarou Sasage, Kawasaki (JP); Akira Satou, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/520,737

(22) Filed: Sep. 14, 2006

(30) Foreign Application Priority Data
May 18, 2006 (JP) 2006-138565

(51) Int. Cl. G11B 21/08

(52) U.S. Cl. 369/30.44

(57) ABSTRACT

A hierarchical storage apparatus includes primary hierarchical storage connected to a host and storing information, a secondary hierarchical storage storing information, a hierarchical control unit controlling the primary hierarchical storage and the secondary hierarchical storage, and a management table for managing information on a logical volume as a recording space on the hierarchical storage apparatus. When a storage medium of the secondary hierarchical storage is replaced with a storage medium in an identical or different secondary hierarchical storage, the hierarchical control unit records identification information of a replacing storage medium of the secondary hierarchical storage on the management table.

### CROSS-REFERENCE TO RELATED APPLICATIONS

This application claims the conventional priority based on Japanese Application No.2006-138565, filed on May 18, 2006, the disclosures of which are incorporated herein by reference.

### BACKGROUND OF THE INVENTION

1. Field of the Invention

The present invention relates to a hierarchical storage apparatus in which primary hierarchical storage of a hard disk apparatus and secondary hierarchical storage of a tape library apparatus and so on are hierarchically configured by a hierarchical control processor (server) in a large-capacity information management system, and method for managing a storage medium of the hierarchical storage apparatus.

2. Description of the Related Art

The conventional information management system is mainly a hard disk array apparatus capable of large-capacity storage and high-speed access, and a magnetic tape medium has been a backup medium (refer to Japanese Patent Laid-Open No. 9-50351).

With the introduction of a hierarchical storage system (apparatus) based on the information life cycle management, an apparatus for using a tape library apparatus for virtual use as a part of a hard disk apparatus has been developed. Correspondingly, it is necessary to have a method of using a plurality of magnetic tape media as a logical volume, not as a conventional backup medium. A tape library apparatus and a tape medium for use in the above mentioned system have shorter lives as compared with the data stored on a hard disk and so on. Therefore, it is necessary to transfer data to a new tape library and a tape medium. However, in the above mentioned case in the conventional technique, it is necessary to switch the operation to a new logical volume after generating a logical volume in an operation and so on from a host using a new tape library and a tape medium, and copying data between the logical volumes.

In the conventional technique, a tape cartridge as a write once storage medium removes invalid garbage data, rearranges only valid data, performs garbage collection for copy, and then transfers data, or performs garbage collection after transferring data. Therefore, it is necessary to separately perform two operations. As a result, three tape cartridges are required including a copy source tape cartridge, a relay tape cartridge, and a copy destination tape cartridge, thereby using a redundant tape cartridge (relay tape cartridge).

There are the following problems with the conventional technique.

When data is transferred to a new tape library or tape medium, it is necessary to generate a logical volume in an operation and so on from the host using a new tape library or tape medium, and switch an operation to a new logical volume after copying data between the logical volumes.

When only valid data is rearranged and make copies using a write once tape cartridge, data is transferred after garbage collection, or the garbage collection is performed after transferring data. Therefore, three tape cartridges are required including a copy source tape cartridge, a relay tape cartridge, and a copy destination tape cartridge, thereby using a redundant tape cartridge (relay tape cartridge).

### SUMMARY OF THE INVENTION

It is an object of the present invention to provide a hierarchical storage apparatus which switches an operation to a new tape library or tape medium while using a logical volume, and simultaneously transfers data to the new tape cartridge and performs garbage collection.

It is another object of the present invention to provide a method for managing a storage medium of the hierarchical storage apparatus which switches an operation to a new tape library or tape medium while using a logical volume, and simultaneously transfers data to the new tape cartridge and performs garbage collection.

The hierarchical storage apparatus of the present invention comprises a primary hierarchical storage connected to a host and storing information, a secondary hierarchical storage storing information, a hierarchical control unit controlling the primary hierarchical storage and the secondary hierarchical storage, and a management table managing information on a logical volume as a recording space on the hierarchical storage apparatus. When the hierarchical control unit replaces a storage medium of the secondary hierarchical storage with a replacing storage medium in an identical or different secondary hierarchical storage, the hierarchical control unit records identification information on the replacing storage medium of the secondary hierarchical storage on the management table.

Preferably, the storage medium of the secondary hierarchical storage is a tape medium.

Preferably, the secondary hierarchical storage includes a write once storage medium. When the hierarchical control unit replaces the write once storage medium with other storage medium, the hierarchical control unit deletes information on garbage data from a management table for the write once storage medium, and transfers the data to the other storage medium according to the management table for the deleted storage medium.

The method for managing a storage medium of a hierarchical storage apparatus of the present invention is the method for managing a storage medium of a hierarchical storage apparatus including a primary hierarchical storage connected to a host and storing information, a secondary hierarchical storage storing information, a hierarchical control unit controlling the primary hierarchical storage and the secondary hierarchical storage, and a management table managing information on a logical volume as a recording space on the hierarchical storage apparatus. The method comprises recording, in the hierarchical control unit, identification information on a replacing storage medium of the secondary hierarchical storage on the management table when a storage medium of the secondary hierarchical storage is replaced with the replacing storage medium in an identical or different secondary hierarchical storage.

According to the hierarchical storage apparatus and method for managing storage medium of the present invention, the following effect can be obtained.

When a storage medium of secondary hierarchical storage is replaced with a storage medium of the same or different secondary hierarchical storage, a hierarchical control unit records the identification information for the replacing storage medium of the secondary hierarchical storage in a management table. Therefore, the hierarchical storage apparatus can replace the generation of a storage medium of the secondary hierarchical storage while continuing the current operation.

The storage medium of the secondary hierarchical storage is a tape medium. Therefore, a less expensive and large capability medium can be used.

When a write once storage medium is replaced with another storage medium, the hierarchical control unit deletes the information on the garbage data from the management table for the write once storage medium, and transfers data to another replacing storage medium according to the management table for the deleted storage medium. Therefore, the hierarchical storage apparatus can perform the transferring of a data to a new storage medium (tape cartridge and so on) and garbage collection can be performed simultaneously while continuing the current operation.

### BRIEF DESCRIPTION OF THE DRAWINGS

FIG. 1 is an explanatory view of the hierarchical storage apparatus according to the present invention.

FIG. 2 is an explanatory view of the database according to the present invention.

FIG. 3 is an explanatory view of the hierarchical storage apparatus in a petabyte scale according to the present invention.

FIG. 4 is a flowchart of the process of generating a valid data list according to the present invention.

### DETAILED DESCRIPTION OF THE PREFERRED EMBODIMENTS

According to the present invention, in an information management system using a tape library apparatus, a hard disk apparatus and a tape library apparatus are hierarchically configured through a hierarchical control server (processor), and a tape inserted into the tape library apparatus can be replaced with another library or a tape of another generation while continuing the current operation in the hierarchical virtual storage (hierarchical storage apparatus) in which a large-capacity storage area can be used.

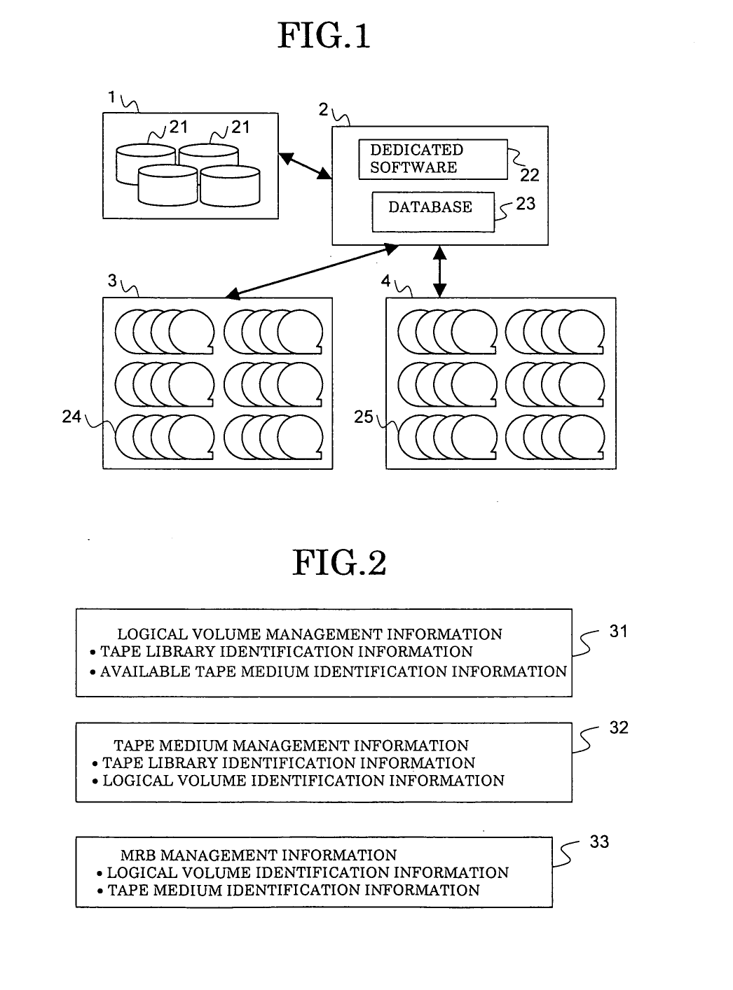

Hereinafter, the hierarchical storage apparatus of the present invention is described. FIG. 1 is an explanatory view of the hierarchical storage apparatus. In FIG. 1, the hierarchical storage apparatus includes a disk array apparatus (primary hierarchical storage) 1, a hierarchical control server (hierarchical control unit) 2, and tape library apparatuses (secondary hierarchical storages) 3 and 4. The disk array apparatus 1 includes a plurality of hard disks 21. The hierarchical control server (hierarchical control unit) 2 includes a hierarchical control software (dedicated software) 22 and the database 23 used for performing hierarchical control. The tape library apparatus 3 includes a tape medium 24 as storage media. The tape library apparatus 4 includes a tape medium 25 as storage media.

The outline of the hierarchical storage apparatus of the present invention is configured as follows.

The hierarchical storage apparatus includes the primary hierarchical storage 1 connected to a host and storing information, the secondary hierarchical storage 3 and 4 storing information, the hierarchical control unit 2 controlling the primary hierarchical storage 1 and the secondary hierarchical storage 3 and 4, and a management table managing the information relating to the logical volume as a recording space on the hierarchical storage apparatus. The management table is described later. When the hierarchical storage apparatus replaces a storage medium of the secondary hierarchical storage 3 with a storage medium of the identical or different secondary hierarchical storage 4, the hierarchical control unit 2 stores the identification information on the replacing storage medium of the secondary hierarchical storage in the management table. Therefore, the generation of the storage medium of the secondary hierarchical storage can be replaced while continuing the operation.

Preferably, the storage medium of the secondary hierarchical storage 3 and 4 is a tape medium. Therefore, a less expensive and large capacity medium can be used.

Preferably, the secondary hierarchical storage 3 and 4 includes a write once storage medium, and when the write once storage medium is replaced with other storage medium, the hierarchical control unit 2 deletes the information on the garbage data from the management table for the write once storage medium, and transfers data to the other storage medium for replacement according to the management table of the deleted storage medium. Therefore, with the operation continued, the transfer of data to a new storage medium (tape cartridge and so on) and the garbage collection can be simultaneously performed.

The disk array apparatus 1 includes the plurality of hard disks 21 forming a RAID (redundant arrays of inexpensive disks) apparatus, and functions as a primary hierarchical storage (hard disk apparatus) connected to a host (host computer) of a user not shown in the attached drawings and the hierarchical control server 2. The hierarchical control server (hierarchical control unit) 2 transfers data between the disk array apparatus 1 and the tape library apparatus 3 as necessary. The tape library apparatuses 3 and 4 are configured by one or more of units. The tape media 24 and 25 of the tape library apparatuses 3 and 4 store all data of the user of the hierarchical storage apparatus.

All data of the users of the present apparatus is stored in the tape media of the tape library apparatuses 3 and 4, the host of the user is connected to the disk array apparatus 1, and the hierarchical control server 2 transfers data between the disk array apparatus 1 and the tape libraries 3 and 4, thereby accessing the data on the tape media 24 and 25 from the host as necessary.

Hereinafter, the database 23 is explained. The recording space on the hierarchical storage apparatus (hierarchical virtual storage apparatus) is controlled for each logical volume, and all the information about a logical volume is managed by the database 23 of the hierarchical control server 2.

FIG. 2 is an explanatory view of the database. In FIG. 2, the database 23 is provided with three management tables, that is, a logical volume management table 31, a tape medium management table 32, and a MRB management table 33.

The logical volume management table 31 is a management table of each logical volume storing logical volume management information, and the types (tape library identification information) of the tape library apparatuses 3 and 4 for use in storing data, and the types (available tape medium identification information) of the tape media 24 and 25 are set in the logical volume management table 31.

The tape medium management table 32 is a management table storing tape medium management information, and the types (tape library identification information) of the tape library apparatuses 3 and 4 for use in storing data and the types of logical volumes (logical volume identification information) are set in the tape medium management table 32.

The logical volume is managed for each block of a predetermined size of MRB (migration recall block), and the identification information (logical volume identification information) of the corresponding logical volume management table 31 and the identification information (tape medium identification information) of the tape medium management table 32 are set in the MRB management table 33.

If a logical volume is set in the logical volume management table 31 for use of the tape medium 24 of the tape library apparatus 3, the tape medium 24 of the tape library apparatus 3 is used when a tape medium is required at a write request of the MRB from the hard disk 21 by a write from the host computer, and the logical volume identification information and the tape medium identification information are recorded on the MRB management table 33.

Hereinafter, tape generation replacement is explained. The information in the logical volume management table 31 is changed such that the tape medium type 25 of the tape library 4 is used as a substitute for the tape medium type 24 of the tape library apparatus 3. Thus, when a new tape medium is required at an MRB write request is issued afterwards, the hierarchical control software 22 uses the tape medium type 25 of the tape library 4.

When an MRB read is requested from the host computer, the hierarchical control software 22 can identify a tape medium from the tape medium identification information in the corresponding MRB management table 33, and can also identify the tape library from the tape library identification information in the corresponding tape medium management table. Thus, although the data of the logical volume are discrete on the tape media of the plurality of tape libraries (3, 4), the library and tape medium in which the MRB is written can be recognized, and the data can be read.

Furthermore, the hierarchical control software 22 copies the MRB on the tape medium 24 of the tape library 3 being used by the logical volume to the tape medium 25 of the tape library 4, and changes the tape medium identification information in the MRB management table. Thus, the data on the tape medium in the tape library 3 can be completely moved to the tape library 4. After all data is completely transferred to the tape library 4, the tape library apparatus 3 can be separated without problem.

When it is necessary to use the tape medium from which data is to be transferred for another use, for example, in a case access request from a host computer is issued, control is performed based on a priority of each process. For example, when an access request is issued to the tape medium by the process of the high priority (for example, a read from the host) during the data transfer, the data transfer is suspended, and the process of the high priority is performed. However, when a tape medium is used for another process, it is necessary to rewind the tape or jump to a marked position of the tape and so on, and the overhead of the time largely increases when the process is frequently suspended. Therefore, the process is not immediately suspended, but the data transfer process during the operation is continued for a predetermined time (for example, 15 minutes, but depending on the performance of the tape).

When the process having a high priority is a write request to copied data, data is written to a copy source tape medium (because of a write once storage medium). When the process is a read request, a copy source or a copy destination is selected. The suspended data transfer process is continued at the point where the suspension has occurred when the process of the high priority is completed.

Thus, according to the present invention, when the tape library or the tape medium currently being operated become obsolete, and a high performance next generation tape library or tape medium is to be used, the tape library or the tape medium can replace while continuing the operation. Furthermore, the tape library 3 and the tape library 4 according to the present invention can realize the data transfer between the medium of the tape library 3 and the medium of the tape library 4 in a same method as the method described above even if the tape library 3 is a DVD library and the tape library 4 is a hard disk (HDD) library and so on, respectively. Additionally, the data can be transferred not only among a plurality of libraries, but also among different media in the single library.

Hereinafter, data transfer using garbage collection is explained. In a hierarchical storage field in the petabyte scale using a disk apparatus as primary hierarchical storage and a tape library apparatus as secondary hierarchical storage, storage materials different in access performance or capacity can be combined to realize a virtual disk space, thereby providing a disk space as large as the storage capacity of the secondary hierarchical storage to the host by a normal disk access. That is, primary hierarchical storage is used as cache memory of the secondary hierarchical storage.

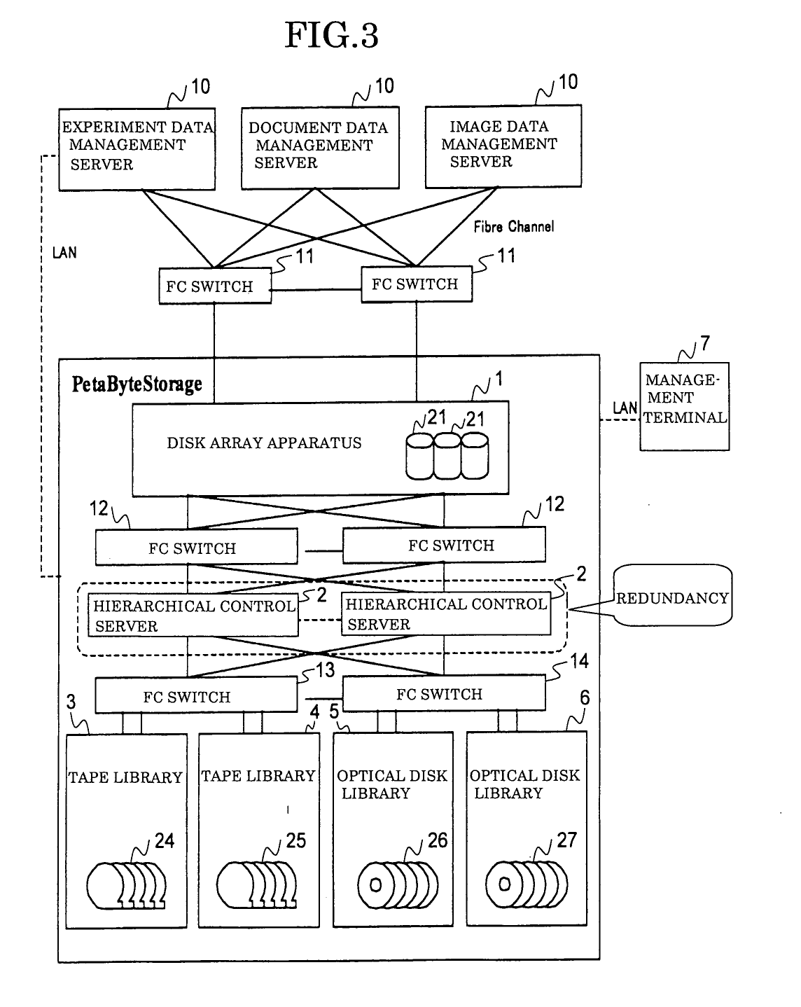

FIG. 3 is an explanatory view of the hierarchical storage apparatus of a petabyte scale. In FIG. 3, the hierarchical storage apparatus of the petabyte scale is connected to a management terminal 7 over a LAN, and is connected to a server 10 (in this example, an experiment data management server, a document data management server, an image data management server) as a host of the user through an FC switch 11. The hierarchical storage apparatus includes the disk array apparatus 1, the hierarchical control server (hierarchical control unit) 2, the tape library apparatus 3 and 4, the optical disk library apparatuses 5 and 6, and the FC switches 12, 13, and 14.

The disk array apparatus 1 includes a plurality of hard disks 21 as storage media. The hierarchical control server (hierarchical control unit) 2 includes software for hierarchical control and a database (storage unit). In this example, two hierarchical control servers 2 are provided for redundancy. The tape library apparatus 3 includes the tape medium 24. The tape library apparatus 4 includes the tape medium 25. The optical disk library apparatus 5 includes the optical disk medium 26. The optical disk library apparatus 6 includes the optical disk medium 27. The management terminal 7 is a management unit by which an operator performs an operation of the hierarchical storage apparatus in a petabyte scale.

The FC switch 11 is a connection unit transferring data between the disk array apparatus 1 and each server 10. The FC (fibre channel) indicates a protocol of a fiber channel. The FC switch 12 is a connection unit transferring data between the disk array apparatus 1 and the hierarchical control server 2. The FC switch 13 is a connection unit transferring data between the hierarchical control server 2 and the tape library apparatuses 4 and 5. The FC switch 14 is a connection unit transferring data between the hierarchical control server 2 and the optical disk library apparatuses 5 and 6.

In the hierarchical storage obtained by combining a disk apparatus and a tape library apparatus, it is necessary to consider the life of the tape cartridge, and transfer user data stored in the tape cartridge to the new tape cartridge. In the write once tape cartridge, for example, an old data before a write for an amendment is made to be invalid (not removed) and a new data for the amendment is written to a new area), and it is necessary to copy data by rearranging only valid data excluding invalid garbage data (garbage collection). Therefore, the present invention provides a function for transferring data to a new tape cartridge and performing the garbage collection simultaneously.

The present invention provides a system of transferring user data stored in the tape cartridge to the newly supported tape cartridge, and a system of performing garbage collection simultaneously. A copy destination cartridge can be a library type specified by an operator from the management terminal 7 (GUI screen), a tape cartridge type and so on, and realizes transfer of data to a library having a different housing, and a tape cartridge of a different generation.

The hierarchical storage apparatus of a petabyte scale as a hierarchical storage system can define a logical volume by using the tape library apparatuses 3 and 4 which are secondary hierarchical storages as virtual disks. When the tape cartridge (medium) is accessed, a necessary tape cartridge is determined and used based on the logical volume management table storing the tape library type (identification) information and the tape cartridge type (identification) information.

After transferring data, the identification information of the tape cartridge forming a logical volume and the identification information of the tape library storing a tape cartridge are updated in the logical volume management table. Simultaneously, the copy source tape cartridge is separate from a logical volume, and the subsequent access is performed on the new tape cartridge in which the copying process is completed. Therefore, data can be transferred in an active state (while continuing an operation).

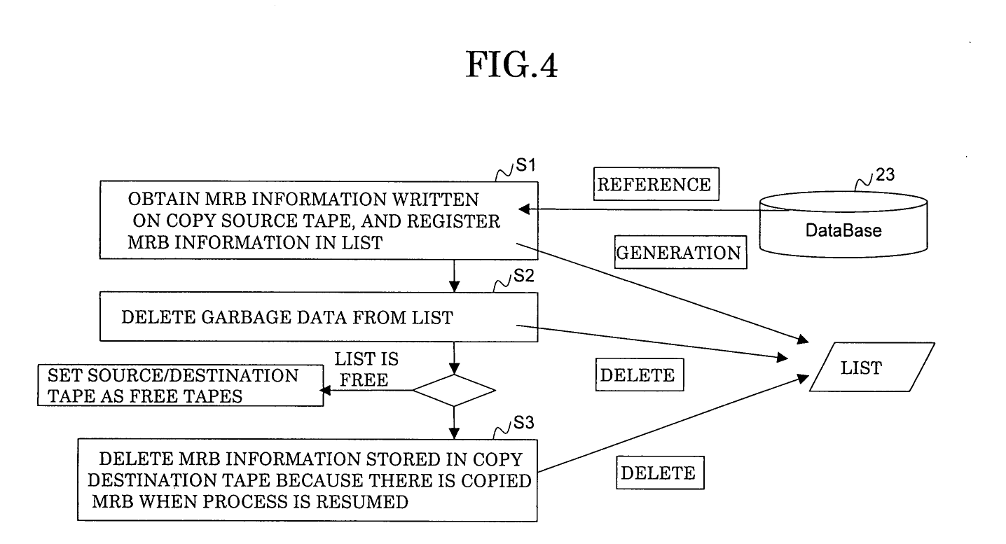

Next, the function of garbage collection performed when data is transferred is explained below. FIG. 4 is a flowchart of the process of generating a valid data list. The garbage collection is realized by performing the process shown in FIG. 4 when data is transferred.

S1: First, the hierarchical control server 2 refers to the database in the hierarchical control server 2 and registers the MRB data stored on the copy source tape is registered in the list (database (storage unit) management table) in the current arrangement. The MRB refers to the minimum unit in which data is communicated in the migration (transfer) and recall between the primary hierarchical storage and the secondary hierarchical storage (for example, 1 MRB=256 MB).

S2: Next, the hierarchical control server 2 deletes the garbage data from the list, and determines whether or not the list is blank. When the list is free, there is all garbage data (not necessary to copy). Therefore, both copy source tape and copy destination tape are set as free tapes. When a plurality of tapes form one logical volume, in some cases, there is data only in other tapes, and a tape can be filled with garbage data (garbage).

S3: The hierarchical control server 2 transfers data based on the list from which the garbage data is deleted. When a cartridge becomes faulty during data transfer with garbage collection, or a rebuilding (reconstruction) from a tape mirroring occurs, the process is suspended. When the process is resumed, the list includes copied MRB. Therefore, the MRB information stored in the copy destination is to be deleted from the list.

With the above described system, a data transfer facility with garbage collection can be realized in an active state of the system (while continuing the operation).

In FIG. 3, as the secondary hierarchical storage, the tape library apparatus and the optical library apparatus are used in the explanation above, but other library apparatus such as a DVD and less expensive hard disk apparatus and so on can also be used.

What is claimed is:

1. A hierarchical storage apparatus, comprising:
a primary hierarchical storage connected to a host and storing information;
a secondary hierarchical storage storing information;
a hierarchical control unit controlling the primary hierarchical storage and the secondary hierarchical storage; and
a management table managing information on a logical volume as a recording space on the hierarchical storage apparatus,
wherein, when the hierarchical control unit replaces a storage medium of the secondary hierarchical storage with a replacing storage medium in an identical or different secondary hierarchical storage, the hierarchical control unit records identification information on the replacing storage medium of the secondary hierarchical storage on the management table.

2. The hierarchical storage apparatus according to claim 1, wherein the storage medium of the secondary hierarchical storage is a tape medium.

3. The hierarchical storage apparatus according to claim 2,
wherein the secondary hierarchical storage includes a write once storage medium, and
wherein, when the hierarchical control unit replaces the write once storage medium with other storage medium, the hierarchical control unit deletes information on garbage data from a management table for the write once storage medium, and transfers the data to the other storage medium according to the management table for the deleted storage medium.

4. The hierarchical storage apparatus according to claim 1,
wherein the secondary hierarchical storage includes a write once storage medium, and
wherein, when the hierarchical control unit replaces the write once storage medium with other storage medium, the hierarchical control unit deletes information on garbage data from a management table for the write once storage medium, and transfers the data to the other storage medium according to the management table for the deleted storage medium.

5. A method for managing a storage medium of a hierarchical storage apparatus including a primary hierarchical storage connected to a host and storing information, a secondary hierarchical storage storing information, a hierarchical control unit controlling the primary hierarchical storage and the secondary hierarchical storage, and a management table managing information on a logical volume as a recording space on the hierarchical storage apparatus, comprising:
recording, in the hierarchical control unit, identification information on a replacing storage medium of the secondary hierarchical storage on the management table when a storage medium of the secondary hierarchical storage is replaced with the replacing storage medium in an identical or different secondary hierarchical storage.
